(19) United States
(12) Patent Application Publication
(10) Pub. No.: US 2013/0041941 A1
(43) Pub. Date: Feb. 14, 2013

(54) Crowd-Sourcing of Information for Shared Transportation Vehicles

(71) Applicants: Anthony Slavko Tomasic, Pittsburgh, PA (US); John Doyle Zimmerman, Pittsburgh, PA (US); Aaron Steinfeld, Pittsburgh, PA (US)

(72) Inventors: Anthony Slavko Tomasic, Pittsburgh, PA (US); John Doyle Zimmerman, Pittsburgh, PA (US); Aaron Steinfeld, Pittsburgh, PA (US)

(73) Assignee: CARNEGIE MELLON UNIVERSITY, Pittsburgh, PA (US)

(21) Appl. No.: 13/639,995

(22) PCT Filed: Apr. 8, 2011
(86) PCT No.: PCT/US11/31710

§ 371 Date: Oct. 8, 2012

Related U.S. Application Data
(60) Provisional application No. 61/342,139, filed on Apr. 9, 2010.

(51) Int. Cl. G06F 15/16

(52) U.S. Cl. 709/203

(57) ABSTRACT

Systems, apparatuses, methods, and software for collecting and disseminating crowd-sourced information relating to one or more shared vehicles, such as buses, passenger trains, subway vehicles, streetcars, etc. The crowd-sourced information is collected via mobile client devices carried by users, such a riders of the shared vehicle at issue. Information collected includes tracing data for tracing the route and timing of each shared vehicles. The tracing data is used to update a computer model that helps predict arrival/departure times. The predicted arrival times can be conveyed to users and to allow people to arrange rendezvous events. Other information collected includes user-report information on items such as condition of the shared vehicle, fullness of the vehicle, and the user's experience with the vehicle and/or corresponding infrastructure. Collected user-report information can be shared with other users and/or a customer service system affiliated with the shared vehicle.

### RELATED APPLICATION DATA

This application claims the benefit of priority of U.S. Provisional Patent Application Ser. No. 61/342,139 filed on Apr. 9, 2010, and titled “Methods, Apparatuses And Systems For Collaborative Determination Of Rendezvous,” which is incorporated by reference herein in its entirety.

### STATEMENT REGARDING FEDERALLY SPONSORED RESEARCH AND DEVELOPMENT

This invention was made in part with government support under the U.S. Department of Education through the National Institute on Disability and Rehabilitation Research Grant No. H133E80019. The United States Government may have certain rights in this invention.

### FIELD OF THE INVENTION

The present invention generally relates to the field of crowd-sourcing of useful information. In particular, the present invention is directed to crowd sourcing of information for shared transportation vehicles.

### BACKGROUND

Mass transit systems, such as city bus, regional rail, and subway systems, provide great benefit to society. However, lack of information about the vehicles and other aspects of the systems can irritate riders and waste the riders' time. For example, because of a host of legitimate issues mass transit vehicles often do not stick to their schedules, and commuters waiting to be picked up become irritated in not knowing when the next vehicle will arrive. Not only are they irritated, but their time can be wasted waiting for a delayed vehicle. As another example, a rider that wants to take her bicycle along with her on a city bus may not know whether a particular bus has a bike rack or, if the bus has a bike rack, whether the rack will have any space available, and this can cause frustration. In addition, these known issues with mass transit systems can cause potential riders to simply avoid them and seek alternative, less desirable (from a societal perspective) modes of transportation.

### SUMMARY OF THE DISCLOSURE

In one implementation, the present disclosure is directed to a method of providing information relating to a shared vehicle. The method includes receiving first tracing information concerning the route of the shared vehicle from a first client device carried by a rider of the shared vehicle, wherein the receiving is a function of the rider initiating transmission of the first tracing information using a begin-transmission feature on the first client device; digitally calculating an estimated arrival/departure time at a destination as a function of the first tracing information; and providing the estimated arrival/departure time to a second client device viewable by a person interested in the arrival/departure time

In another implementation, the present disclosure is directed to a method of collecting and receiving information relating to a shared vehicle. The method includes displaying to a user on a client device an identifier of the shared vehicle; receiving from the user via the client device a selection indicating the shared vehicle; in response to the receiving the selection indicating the shared vehicle, causing the client device to transmit an indication of the selection to a remote shared vehicle information server; displaying to the user on the client device a first control for initiating transmission of trace information generated by the client device; receiving from the user via the client device a selection of the first control; in response to the receiving the selection of the first control, transmitting the trace information to the remote shared vehicle information server; displaying to the user on the client device an input mechanism that allows the user to input user-report information relating to the shared vehicle; receiving from the user via the input mechanism the user-report information; and transmitting the user-report information to the remote shared vehicle information server.

In still another implementation, the present disclosure is directed to a method of providing information relating to a shared vehicle. The method includes electronically receiving crowd-sourced trace data for a shared vehicle that runs on a schedule; automatedly updating a schedule-based computer model for the shared vehicle as a function of the crowd-sourced trace data so as to create an updated model; and electronically providing updated schedule information based on the updated model to a mobile client device carried by a user.

In yet another implementation, the present disclosure is directed to a machine-readable storage medium containing machine-executable instructions for performing a method of providing information relating to a shared vehicle. The machine-executable instructions include a first set of machine-executable instructions for receiving first tracing information concerning the route of the shared vehicle from a first client device carried by a rider of the shared vehicle, wherein the receiving is a function of the rider initiating transmission of the first tracing information using a begin-transmission feature on the first client device; a second set of machine-executable instructions for digitally calculating an estimated arrival/departure time at a destination as a function of the first tracing information; and a third set of machine-executable instructions for providing the estimated arrival/departure time to a second client device viewable by a person interested in the arrival/departure time.

In still yet another implementation, the present disclosure is directed to a machine-readable storage medium method of collecting and receiving information relating to a shared vehicle. The machine-readable storage medium method includes a first set of machine-executable instructions for displaying to a user on a client device an identifier of the shared vehicle; a second set of machine-executable instructions for receiving from the user via the client device a selection indicating the shared vehicle; a third set of machine-executable instructions for causing the client device to transmit an indication of the selection to a remote shared vehicle information server in response to the receiving the selection indicating the shared vehicle; a fourth set of machine-executable instructions for displaying to the user on the client device a first control for initiating transmission of trace information generated by the client device; a fifth set of machine-executable instructions for receiving from the user via the client device a selection of the first control; a sixth set of machine-executable instructions for transmitting the trace information to the remote shared vehicle information server in response to the receiving the selection of the first control; a seventh set of machine-executable instructions for displaying to the user on the client device an input mechanism that allows the user to input user-report information relating to the shared vehicle; an eighth set of machine-executable instructions for receiving from the user via the input mechanism the user-report information; and a ninth set of machine-executable instructions for transmitting the user-report information to the remote shared vehicle information server.

In a further implementation, the present disclosure is directed to a machine-readable storage medium of providing information relating to a shared vehicle. The machine-readable storage medium includes a first set of machine-executable instructions for receiving crowd-sourced trace data for a shared vehicle that runs on a schedule; a second set of machine-executable instructions for updating a schedule-based computer model for the shared vehicle as a function of the crowd-sourced trace data so as to create an updated model; and a third set of machine-executable instructions for providing updated schedule information based on the updated model to a mobile client device carried by a user.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagram illustrating a shared vehicle information system for providing details concerning a shared vehicle based on crowd-sourced of information;

FIG. 2 is a block diagram of a mobile client device that can be used in the system of FIG. 1;

FIG. 3 is a block diagram of a server that can be used in the system of FIG. 1;

FIG. 4 is a flow diagram of an exemplary process that can be performed by the client application of FIG. 2;

FIG. 5 is a flow diagram of an exemplary process that can be performed by the server application of FIG. 3;

FIG. 6 is a high-level diagram illustrating an exemplary city-bus information system for providing details concerning transit agency buses;

FIG. 7 is a screenshot of a main menu screen of a graphical user interface (GUI) of the bus information client application FIG. 6;

FIG. 8 is a screenshot of a map screen of the GUI of FIG. 7;

FIG. 9 is a screenshot of a select route screen of the GUI of FIG. 7;

FIG. 10 is a screenshot of destination screen of the GUI of FIG. 7;

FIG. 11 is a screenshot of an record screen of the GUI of FIG. 7;

FIG. 12 is a screenshot of an end-record screen of the GUI of FIG. 7;

FIG. 13 is a screenshot of a report type screen of the GUI of FIG. 7;

FIG. 14 is a screenshot of a report submission screen of the GUI of FIG. 7; and

FIG. 15 is a high-level diagram of an exemplary software-driven machine capable of implementing systems and methods of the present invention.

### DETAILED DESCRIPTION

Aspects of the present invention are directed to providing useful information about one or more shared vehicles based on crowd-sourced information. Such useful information includes the location(s) of the shared vehicle(s), as well as information on one or more conditions of each shared vehicle (such as fullness of the vehicle, presence of a broken air conditioner, etc.), information about features available on a shared vehicle (such as presence of a bike rack, presence of accommodations for wheeled mobility devices, etc.), and information of other aspects relating to the vehicle (such as missing bus-stop sign at the bus, unfriendliness of a driver, etc.), among others. As used herein and the appended claims, the term “shared vehicle” and like terms refers to vehicles that are shared, either contemporaneously or sequentially, or both, among two or more people. Examples of shared vehicles include: buses, trains and other railed, maglev, etc., vehicles; aircraft; passenger ships; ferries; limousines; and car-sharing vehicles, among others. As will be seen below, locational information about shared vehicles can be useful for providing other information, such as schedule information for shared vehicles that run regular routes on predetermined schedules (e.g., predicted arrival time deviations from a predetermined schedule) and rendezvous information (e.g., a predicted arrival time at a designated destination) that allows one or more people to coordinate rendezvousing with the shared vehicle or one or more people on the shared vehicle, among others. These and other features of a shared vehicle information scheme of the present invention are described below levels of both generality and specificity. Both levels should give the reader an understanding of the breath and usefulness of the present invention.

### Overview

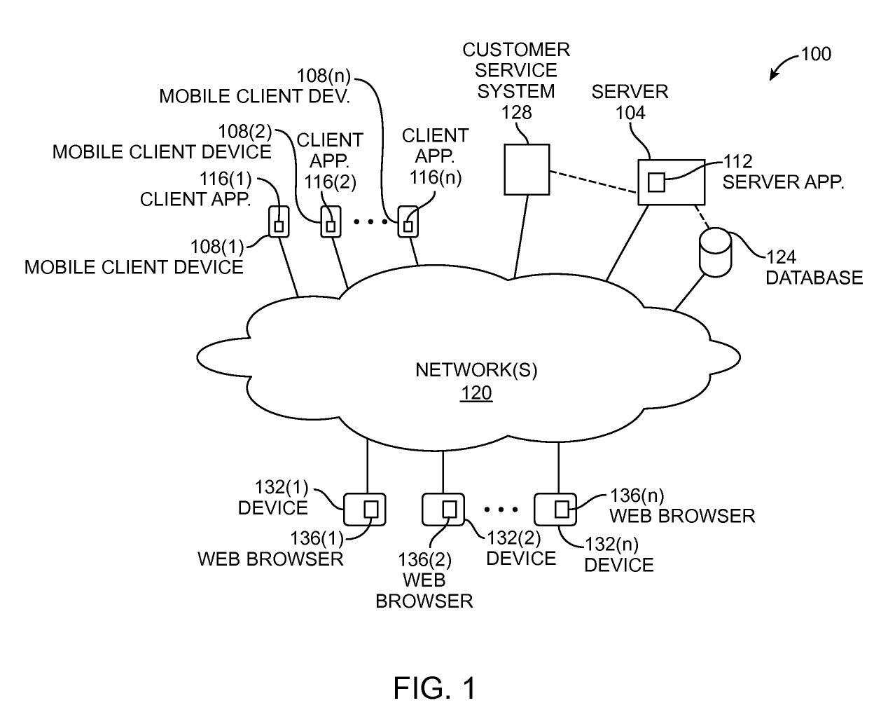

Referring now to the drawings, FIG. 1 shows an exemplary shared vehicle information system 100 designed and configured to collect and promulgate information concerning one or more shared vehicles (not shown). System 100 includes one or more servers (collectively represented as server 104) and a plurality of mobile client devices 108(1) through 108(n) (or 108(1)-(n), for short) that are carried by people that ride the shared vehicle(s) or otherwise have an interest in knowing information about and/or relating to the shared vehicle(s). Server 104 executes a shared-vehicle information server application 112 and each mobile client device 108(1)-(n) runs a corresponding shared-vehicle client application 116(1) through (n) that communicates with server application 112 over one or more communications networks (represented collectively by network 120) in a manner that allows system 100 to provide any one or more of the unique functionalities disclosed herein.

As mentioned above, system 100 utilizes crowd-sourced information about/relating to the shared vehicle(s) as a basis for its functionality, and some or all of mobile client devices 108(1)-(n) and their users are the source of this crowd-sourced information. A characteristic of mobile client devices 108(1)-(n) is that they are devices that the users carry with them when they use the shared vehicle(s). Presently, smartphones are virtually ubiquitous devices that their users typically carry with them nearly constantly when out and about in public, and so, smartphones are presently desirable devices for implementing as mobile client devices 108(1)-(n). Indeed, current smartphones typically have instruments and features, such as global positioning systems (GPSs), Wi-Fi transceivers, graphic-display-based user interfaces, general purpose microprocessors, etc., that a shared vehicle information system of the present disclosure, such as system 100, can leverage, such that they are a natural target for use as mobile client devices 108(1)-(n). In such cases, all that typically needs to be done to make them suitable mobile client devices 108(1)-(n) is to load them with client applications 116(1)-(n) that are designed and configured to provide the smartphones with the requisite functionality. That said, those skilled in the art will readily appreciate that each mobile client devices 108(1)-(n) can be any other suitable device, such as a tablet computer (e.g., an iPad™ device available from Apple, Inc., Cupertino, Calif.), a personal gaming device, a personal multimedia device (e.g., an Apple iPod® device), a dedicated client device, among others. The form(s) of mobile client devices 108(1)-(n) is/are generally not critical; rather, it is the functionality such devices provide that is more important. That said, whatever the nature of mobile client devices 108(1)-(n), the devices must be devices that the users are willing to actually use. Similarly, server 104 can comprise any suitable hardware that can execute server application 112.

Network 120 can be any one or more communications networks/paths needed for mobile client devices 108(1)-(n) and server 104 to communicate with one another. Examples of such networks/paths include, but are not limited to, wide-area networks, such as the Internet, cell-tower networks, local area networks, cable networks, among others, and any interconnections therebetween and to server 104 and mobile client devices 108(1)-(n).

In addition to mobile client devices 108(1)-(n), server 104 may be in communication with a database 124 that contains information relating to the shared vehicle(s) under consideration, such as scheduling information, route information, and equipment identifiers, and one or more models relating thereto. Database 124 could, for example, be maintained by an entity having authority over the shared vehicle(s), such as a mass transit authority of a private owner of the vehicle(s). In addition, server 104 and database 124 could each be under control of the same or differing parties other than the entity having authority over the shared vehicle(s) at issue. Depending upon the type of condition information that system 100 crowd sources from users of mobile client devices 108(1)-(n), server 104 may also be in communication with a customer service system 128 of the owner/operator of the shared vehicle(s). Depending on the condition at issue, customer service system 128 can log an incident and initiate a follow up, for example, someone in charge of maintenance of the shared vehicle at issue.

Server 104 may also be in communication with one or more devices 132(1)-(n) that users typically do not carry with them or do not carry with them with the frequency of mobile client devices 108(1)-(n). Examples of such devices include, but are not limited to, desk-top computers, laptop computers, tablet computers, and Internet appliances. In some embodiments of system 100, server 104 can communicate with devices 132(1)-(n), for example, via web browsers 136(1)-(n). In this manner, users of devices 132(1)-(n) could have access to the same shared-vehicle information that server 104 makes available to mobile client devices 108(1)-(n) via client applications 112(1)-(n). It is noted that the more mobile ones of devices 132(1)-(n), such as the tablet computers and laptops, could also be loaded with a client application that is the same as client applications 112(1)-(n) so that their users could use them in the manner of mobile devices 108(1)-(n) as described below on the occasions that they do carry them with them.

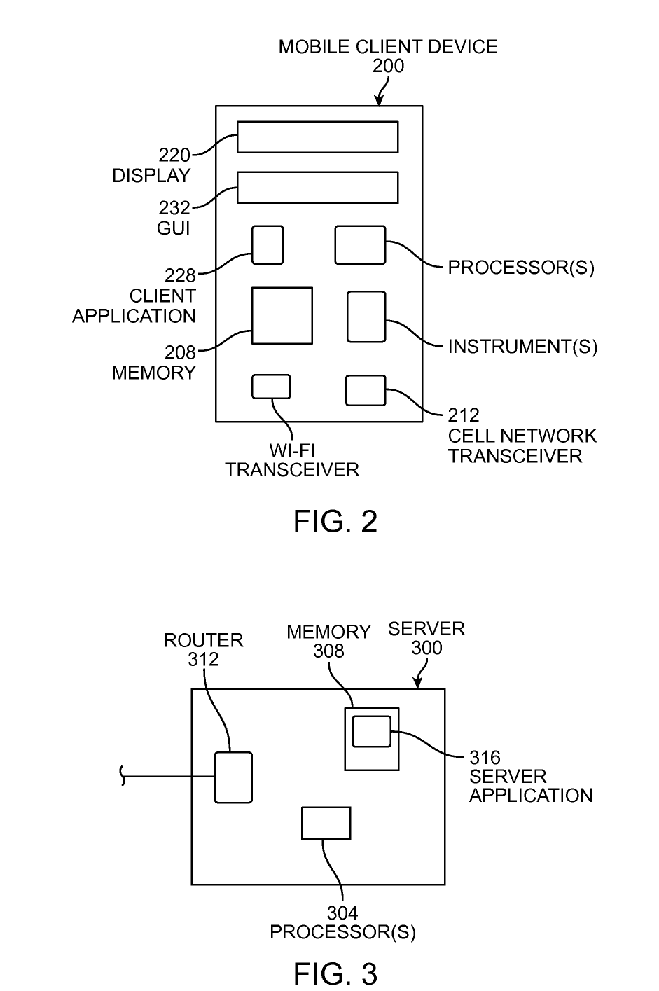

FIG. 2 illustrates an exemplary mobile client device 200 that is suitable for use as any one of client device 108(1)-(n) of FIG. 1. Referring to FIG. 2, client device 200 is an electronic computing device that contains at least one processor 204, memory 208, one or more network interfaces, such as cell network transceiver 212 and/or a Wi-Fi transceiver 216, an electronic display 220, and one or more instruments (collectively represented by instrument(s) 224) that provide data relating to the location and/or movement of the client device, such as a GPS, a magnetometer, an accelerometer, etc. Memory 208 contains a shared-vehicle information client application 228, such as one of client applications 112(1)-(n), that when executed by processor 204 provides a graphical user interface (GUI) 232 that implements aspects of the shared-vehicle information functionality disclosed herein as being provided by a mobile client device. A description of this functionality and examples thereof are presented below.

FIG. 3 illustrates and exemplary server 300 that is suitable for use as server 104 of FIG. 1. Server 300 includes one or more processors 304, memory 308, and an interface, such as a router 312, that connects the server to a network, such as network 120 of FIG. 1. Memory 308 contains a shared-vehicle information server application 316 that implements aspects of the shared-vehicle information functionality disclosed herein as being provided by a server. A description of this functionality and examples thereof are presented below.

### Crowd Sourcing of Shared-Vehicle Location

A feature of a shared vehicle information system of the present disclosure, such as system 100 of FIG. 1, is the tracking of one or more shared vehicles using crowd-sourced trace data. For convenience of illustration, this explanation refers to FIGS. 1 to 3 for context. For any given shared vehicle, its physical location can be tracked substantially in real time by one or more of mobile client devices 108(1)-(n) that are aboard that shared vehicle and/or by shared vehicle information server 104 of FIG. 1 when it is collecting locating data in real time from one(s) of the mobile client devices known, or at least suspected, to be aboard that vehicle by virtue of the user(s) of such device(s) being aboard the vehicle. In the case of tracking by any of mobile client devices 108(1)-(n), it is noted that the tracking information, i.e., the set of locating data at various points in time, does not need to be provide by server 104 in real time. Rather that mobile client device 108(1)-(n) can store the information and then provide it to server 104 at another time. Server application 112 could still use that information to update its model for that shared vehicle. For the rest of this description, it is assumed that every mobile client device 108(1)-(n) at issue is known to be aboard the shared vehicle at issue for an identified amount of time. As will be recognized, however, system 100 does not always know whether or not a mobile client device is definitively aboard a particular vehicle (e.g., a user may misidentify the vehicle or the system may not know which of multiple vehicles using the same route that the client device is on) nor does the system always know precisely when the device is moved off the vehicle (e.g., a user may forget to turn off location recording at the end of a ride or an automated disembarkation determining may not have sufficient data for working properly). However, these exceptions can be handled using suitable techniques.

While any of client devices 108(1)-(n) are aboard the shared vehicle at issue, they can be providing real-time tracing information to server 104 and/or be collecting the tracking information, for example, for later uploading to the server (referred to herein and in the appended claims as “delayed” data). A mobile client device 108(1)-(n) can be known by server application 112 to be aboard the shared vehicle in real time, for example, by the user identifying the vehicle to the server application when the user first boards the vehicle. This can be accomplished in any of a number of ways, such as by the user making a selection from among a list of vehicle identifiers (or, more typically, route identifiers) displayed by GUI 232. Other ways of a user identifying a vehicle they are boarding include entering an identifier into GUI 232 manually or automatically, such as by scanning a mobile tagging code affixed to or otherwise displayed on the vehicle. Depending on the configuration of client applications 116(1)-(n) and server application 112, locating data can be either pulled from a mobile client device 108(1)-(n) by the server application, for example, by periodically requesting locating data, or the client application can push the locating data to the server application periodically. It is noted that the selecting of the vehicle identifier as noted above can be used to initiate the locating information pushing or pulling process. Alternatively, client applications 116(1)-(n) could be configured to require the user to take another action to initiate the data transfer, such as the selecting of a record button.

Types of locating data that system can utilize include GPS data, magnetometer data, Wi-Fi “hotspot” locational data, and cell network triangulation data, among others, and combinations thereof. Those skilled in the art will understand how to select and utilize particular locating data type suitable for a particular shared vehicle information system application, such that further description thereof is not necessary for them to understand the breadth of the present invention and implement it to the fullest scope as explained herein and defined by the appended claims.

At times, multiple mobile client devices 108(1)-(n) will be aboard a particular shared vehicle at the same time, for example, in the manner just discussed. Since current generation mobile client devices 108(1)-(n) have fairly limited battery capacity, it is desirable to minimize usage of locating-data-providing instruments 224 and, if providing data in real time to server 104, network interface(s) 212, 216. In this connection, server application 112 can optionally be designed to recognize that multiple mobile client devices 108(1)-(n) are simultaneously aboard a particular shared vehicle and adjust the rates at which those devices collect locating data and, if providing data in real time to server provide the data to the server. In the context of providing locating data in real time to server 104, depending on whether the locating data is provided in a push or pull manner, server application 112 and/or client device applications 116(1)-(n) can be configured accordingly to either poll mobile client devices 108(1)-(n) less frequently or cause the mobile client devices to push the data less frequently.

One use of the locating data by server application 112 is to provide real-time location information of the corresponding shared vehicle to mobile client devices 108(1)-(n) and/or other, such as devices 132(1)-(n). For example, GUI 232 of each client application 116(1)-(n) can be provided with a map feature (not shown) that displays and interactive map that displays, in substantially real time, the current location of the shared vehicle based on locational information provided by server application 112. Other uses include arrival and/or departure time prediction and schedule updating, examples of which are described below.

### Predicting Shared Vehicle Arrival/Departure Times

With the availability of locating data from at least one, but optimally many, of mobile client devices 108(1)-(n), server application 112 can readily be designed to predict arrival and/or departure time(s) for each shared vehicle relative to one or more particular points, such as bus stops, train stations, ferry docks, airports, etc., along the route of that shared vehicle. (As used herein and in the appended claims, the term “arrival/departure time” means an arrival time or a departure time, or both. Likewise for the plural form.) For example, server application 104 can be configured to use current real-time locating data and/or delayed locating data from one or more mobile client devices 108(1)-(n) in combination with distance-to-next-point data and/or historical locating data collected on prior runs of the same or another shared vehicle on the same route to predict an arrival time and/or departure time for the current shared vehicle to that point. Historical and incoming locating data can be stored in database 124 at server 104 and can be manipulated as needed for arrival and/or departure time prediction by server application 112. Historical locating data can be particularly useful in the context of shared vehicles, such as buses, trains, ferries, monorails, etc. that run on regular schedules from day to day, week to week, etc., and continually throughout the day. Those skilled in the art will readily be able to implement appropriate arrival and/or departure time prediction algorithms used the crowd sourced locating data, such that further description thereof is not necessary for them to understand the breadth of the present invention and implement it to the fullest scope as explained herein and defined by the appended claims.

An exemplary use of predicted arrival and/or departure times is that server application 112 and client applications 116(1)-(n) can be configured to allow a user to query server 104 for the predicted arrival and/or departure times of a particular shared vehicle at a particular point. Another use of predicted arrival and/or departure times is that published schedules can be augmented or updated with the predicted arrival and/or departure time information. Yet another use of predicted arrival and/or departure times is for the scheduling of rendezvous events and functionality relating thereto.

### Rendezvous Events and Functionality

A “rendezvous event” is a meeting up of a first person or first group of people with a particular shared vehicle or a second person or second group of people on the shared vehicle at a particular point in time. As can be appreciated, with system 100 predicting an arrival and/or departure time of the shared vehicle in the crowd-sourced-information-based manner discussed above, with some additional information about the first person/group, system 100 can be configured to facilitate a rendezvous event between the first person/group with the shared vehicle or second person/group. For example, in a case in which the first person/group is not already at the rendezvous location such that they must travel to the rendezvous point, system 100 can be configured to provide the first person/group with a predicted time for them to begin their travel to the rendezvous point to meet the shared vehicle (and the second person/group). System 100 can also be configured to issue a reminder notification to the first person/group that they should begin their travel to the rendezvous point to meet the shared vehicle (and the second person/group). Both of these functionalities can be implemented, for example, via one of mobile client devices 108(1)-(n) or one of devices 132(1)-(n) that is in the possession or proximity of the first person/group. Following is a scenario that illustrates rendezvous functionality that can be built into system 100.

In this example, a student is in her apartment, which is half a mile from a bus stop where she wants to rendezvous with a friend that will be arriving at the bus stop (i.e., the rendezvous point) on a particular bus. The student will be walking to the bus stop to meet her friend, a walk that she knows typically takes 8 minutes. In this example, each of the student and the friend have one of mobile client devices 108(1) and 108(2), which in this case are smartphones. When the friend gets onto the bus, she sends a text message to the student using her mobile client device 108(2) that she is on the bus and provides the bus's identifier. The student then uses her mobile client device 108(1) to enter, via client application 116(1), information to create a rendezvous event. Client application 116(1) prompts the student to enter the bus identifier, bus stop identification, and the estimated time it will take her to get to the bus stop, and client device 104(1) provides this information to server application 112. Server application 112 then uses this information to calculate a reminder time based on the predicted arrival and/or departure time and to send a reminder to client device 104(1) at the appropriate time. For example, based on the 8-minute walk time input by the student, server application 112 might determine that it should send a reminder 15 minutes earlier than the then-predicted arrival and/or departure time to give the student time to get ready to leave. Then when the reminder time arrives, server application 112 pushes the reminder notification to the student's mobile client device 108(1). When mobile client device 108(1) receives the reminder notification, it causes an alert, such as an alarm, vibration, etc., for perception by the student.

Those skilled in the art will readily appreciate that the foregoing example is merely illustrative and is not limiting. Indeed, within the basic framework of rendezvous functionality skilled artisans will recognize that there are many variations that can be implemented to achieve that same result of effecting a rendezvous based on crowd-sourced locating data. For example, instead of the student inputting an estimated travel time to the rendezvous point, system 100 may prompt the student for the transportation mode she is using to get to the rendezvous point. System 100 may then be configured to calculate reminder times using that information and knowing the student's location based on locating data from her mobile client device 108(1).

### Crowd Sourcing of User-Report Information

As mentioned briefly above, system 100 can be optionally configured to handle crowd-sourcing of information concerning and/or relating to the shared vehicle at issue. Such information can be any suitable information about the condition of the shared vehicle and factors influencing the user's experience with or relating to the shared vehicle. Examples of conditions of the shared vehicle include, but are not limited to, the fullness of the vehicle and physical features of the vehicle, such as broken seats, insufficient air conditioning, etc. Other facts of possible interest to potential riders of a particular shared vehicle include the presence of a bike rack (such as on a city bus) and/or availability thereon, whether or not there are accommodations/room for wheeled mobility devices (such as wheelchairs), luggage, etc., problems at the embarkation/debarkation location(s) (e.g., bus stops), unfriendly operator/attendant, accessibility barriers, etc. This type of information is referred to herein and in the appended claims as “user-report information” based on the fact that its original source is a user.

Client applications 116(1)-(n) can be configured to handle receiving user-report information from a user in any of a variety of ways. For example, for user-report information about conditions and other facts that have a two or more discrete states, client applications 116(1)-(n) can display to the user a set of selection controls. For example, for fullness of the shared vehicle, client applications 116(1)-(n) could display selectors having the following labels: “Empty,” “Seats Available,” “No Seats,” and “Full.” Similarly, for a bike rack, there could be four selectors labeled “Yes,” “No,” “Space Available,” and “Full.” The same sort of selection mechanism could be provided for wheeled mobility devices. For conditions and other user-report information not having such discrete states, client applications 116(1)-(n) could be configured to receive a freeform description and/or photograph from the user. When the users are done inputting user-report information on one or more conditions, they typically take an action the causes client devices 108(1)-(n) to transmit the information to server 104.

When server 104 receives the user-report information, it takes an appropriate action, which includes making the information available to client applications 116(1)-(n) and/or to customer service system 128. Server 104 typically provides information such as fullness, bike rack accommodations, and wheeled mobility device accommodations on a real-time basis to client applications 116(1)-(n) because that is information that other users interested in a particular shared vehicle want to know in order for them to make a decision on whether or not the rendezvous with that shared vehicle. For vehicle problems and other information not necessarily needing real-time treatment, server can be configured to provide that information to, for example, customer service system 128.

### Exemplary Client and Server Application Processes

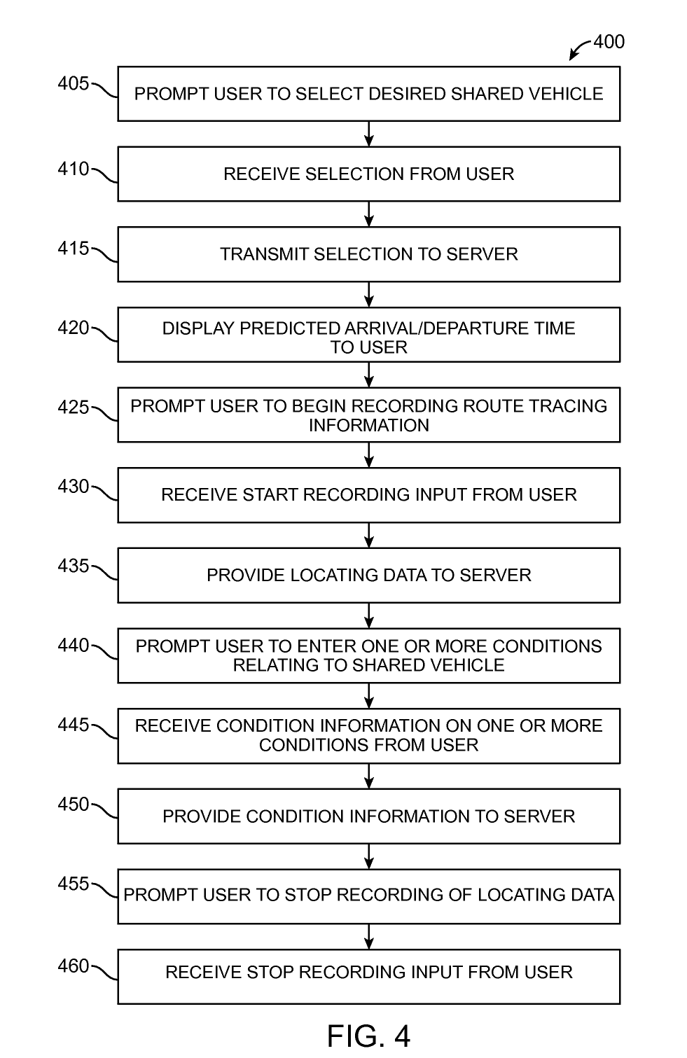

FIG. 4 illustrates and exemplary process 400 that client applications, such as client applications 116(1)-(n) can perform. Those skilled in the art will appreciate that process 400 is merely exemplary and that many modifications and additions can be made to it for implementing a desired shared vehicle information system that is based on crowd-sourced information. That said, for convenience of explanation and general context, process 400 is described in conjunction with system 100 of FIG. 1 and mobile client device 200 of FIG. 2, which again represents any one of mobile client devices 108(1)-(n) of FIG. 1. It is noted that the order of the presented steps is not necessarily the order in which the steps need to be executed. Of course, some will need to be executed before others; however, where there is no natural order, the ordering of the steps can be different for different implementations.

At step 405, client application 228 (FIG. 2) prompts the user via GUI 232 to select a desired shared vehicle that the user is planning on boarding. This can be done in any of a variety of ways, including displaying a list of possible shared vehicles to the user and allowing the user to select one of the listed vehicles. At step 410, client application 228 receives the selection of the shared vehicle from the user. As those skilled in the art will readily appreciate, this can be done via a soft control on GUI 232, for example. At step 415, mobile client device 200 transmits the selection to sever 104 (FIG. 1), for example, using cell network transceiver 212. At step 420, mobile client device 200 displays a predicted arrival (departure) time to the user on GUI 232. This can be done in a number of ways, such as in conjunction with schedule information provided by server 104.

At step 425, client application 228 prompts the user via GUI 232 to start recording route tracing information, i.e., locating data. At step 430, client application 228 receives an input from the user to start recording the tracing information via GUI 232. In one example, GUI displays a “Start Recording” soft control (not shown) to the user. At step 435, mobile client device 200 provides the locating data to server 104 for recording. As mentioned above, this can be done either in real time or on a delayed basis. The way in which recording will be accomplished will typically depend on whether system 100 is set up to push or pull the locating data. These differing setups are discussed above in connection in the section “Crowd Sourcing of Shared-Vehicle Location.”

At step 440, which can be optional, client application 228 prompts the user via GUI 232 to enter user-report information on one or more facts/issues relating to the selected shared vehicle. Examples of such user-report information are described above in the section “Crowd Sourcing of Shared Vehicle Condition Information.” At step 445, client application 228 receives condition information from the user via GUI 232. Examples of how client application 228 can receive this information are also described above in that section. In At step 450, mobile client device 200 provides the condition information to server 104. As with the locating data, this can be done either real time, for example, in immediate response to the user selecting an appropriate control on mobile client device 200 or in a delayed manner.

At step 455, client application 228 prompts the user via GUI 232 to stop recording locating data when the user exits the selected shared vehicle. At step 460, client application 228 receives a stop-recording input from the user via GUI 232. How client application 228 reacts to this input will typically depend on whether the locating data is pushed to server 104 or pulled by the server and depending on whether the data is being provided in a real time or delayed manner. If the locating data is being pushed to server 104 in real time, for example, client application 228 may be configured to stop client 200 from acquiring and transmitting locating data to server 104 and, perhaps, also transmit to the server an indication that the trip has ended. On the other hand, if the locating data is being pulled by server 104 in real time, then client application 228 may be configured to transmit only the indication that the trip has ended. Server application 112 could then act on that indication by ending the data-pulling operations.

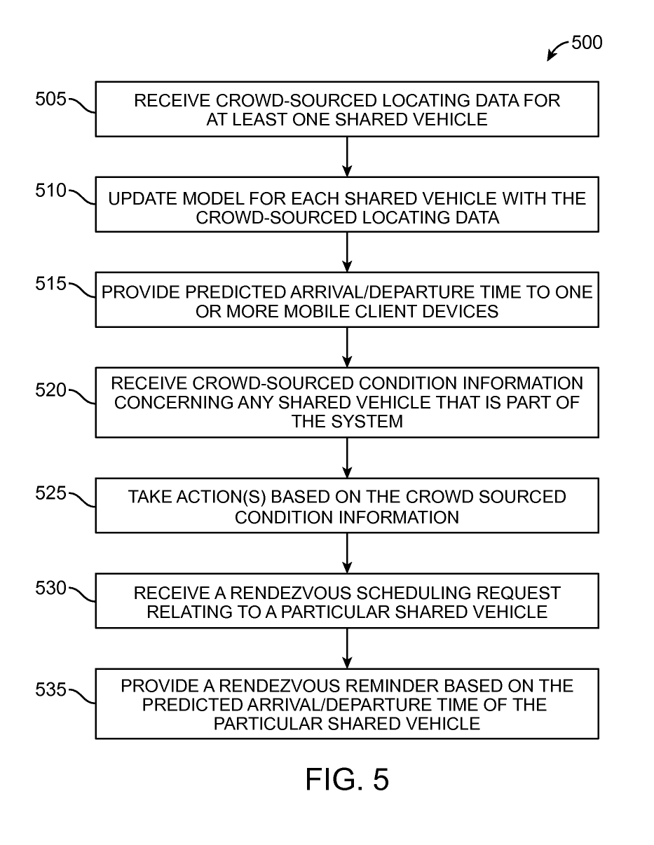

FIG. 5 illustrates an exemplary process 500 that a server application of the present disclosure, such as either of server applications 112 and 316, can perform. Those skilled in the art will appreciate that process 500 is merely exemplary and that many modifications and additions can be made to it for implementing a desired shared vehicle information system that is based on crowd-sourced information. That said, for convenience of explanation and general context, process 500 is described in conjunction with system 100 of FIG. 1 and server 300 of FIG. 3, which again can represents server 104 of FIG. 1. It is noted that the order of the presented steps is not necessarily the order in which the steps need to be executed. Of course, some will need to be executed before others; however, where there is no natural order, the ordering of the steps can be different for different implementations.

At step 505, server application 316 receives crowd-sourced locating data for at least one shared vehicle. This locating data will come, for example, from any one or more of mobile client device 108(1)-(n) (FIG. 1) as described above in the section “Crowd Sourcing of Shared-Vehicle Location.” At step 510, server application 316 updates its model with the incoming locating data for each shared vehicle having incoming data. As discussed above, the model will typically be a combination of historical data and the incoming data, which can be real time or delayed. As part of the model updating, server 300 can keep predicted arrival and/or departure time(s) for one or more destinations of each shared vehicle up to date. At step 515, server application 316 provides one or more predicted arrival and/or departure times to one or more mobile client devices 108(1)-(n) and/or devices 132(1)-(n). Those skilled in the art will appreciate that this can be done in any of a variety of ways, such as by posting the time(s) to one or more preconfigured schedules or by providing the time(s) upon request.

At step 520, server application 316 receives crowd-sourced user-report information concerning at least one shared vehicle or otherwise relating to a shared vehicle. This information will come, for example, from any one or more of mobile client device 108(1)-(n) (FIG. 1) and can be of the nature and character as described above in the section “Crowd Sourcing of User-Report Information.” At step 510, server application 316 takes action based on the crowd sourcing information. As also described above in the “Crowd Sourcing of User-Report Information” section, the action taken will be a function of the type(s) of the user-report information. For example, if the designed use of the user-report information is real-time in nature, server application 316 can make it immediately available to users via their mobile client devices 108(1)-(n) and/or devices 132(1)-(n). On the other hand, if the use of user-report information is not real-time in nature, server application 312 can take another action, such as reporting the information to customer service system 128 as described above.

If server application 316 is so configured, at step 530 server 300 may receive a rendezvous scheduling request from a user for scheduling a rendezvous event. Rendezvous events and functionality are described above in the section of the same name. In response to such request, at step 535 server application 316 calculates and provides a rendezvous reminder based on the then-current predicted arrival (departure) time. An example of such a rendezvous reminder is also discussed above in the “Rendezvous Events and Functionality” section.

### City Bus Example

FIG. 6 illustrates and specific example of a shared vehicle information system made in accordance with the present invention, specifically a city-bus information system 600 that utilizes crowd sourced information. In system 600, a single backend server 604 maintains a client-server arrangement 608 with multiple clients, collectively represented at 612. In an actual test bed, clients 612 ran on iPhone® smartphones from Apple, Inc. Clients 612 contain a user interface 616 and a data model 620 that records favorite stops. Server 604 logs recorded (traced) trips, predicts arrival times, logs fullness, logs problem reports, and processes client information query requests.

To initialize system 600, a general transit feed specification (GTFS) representation of the transit agency schedule is loaded from a GTFS database 624 to a server database 628. In this example, every thirty seconds a real-time model 632 predicts bus arrival time and fullness for buses with trace data within the last 30 seconds. Once a day, server 604 uses the previous month of recorded trips to construct a historical model 636 of bus arrival times and fullness. Both arrival-time prediction models 632, 636 first prune outliers and then regress the distance the bus must travel to a stop against the absolute time of the arrival at that stop. This process is robust against a variety of sources of error in the system, such as bad locating data, dropped trace signals, and user error. Similarly, the real-time and historical fullness models 632, 636 are based on a simple average of past fullness. Models can be generated based on days of the week, weekends, and holidays. Models 632, 636 predict bus location and fullness approximately 20 minutes into the future.

Clients 612 issue three types of requests to server, namely, trace messages 640, reports 644, and informational queries 648. Trace messages 640 contain locating data, fullness, departing-stop, destination-stop, bus route, and a trip identifier. Reports 644 (containing selected options, text and an optional photo) are written directly to server database 628. Informational queries 648 (e.g., nearest bus stops for client 612) are processed against the current state of server database 628.

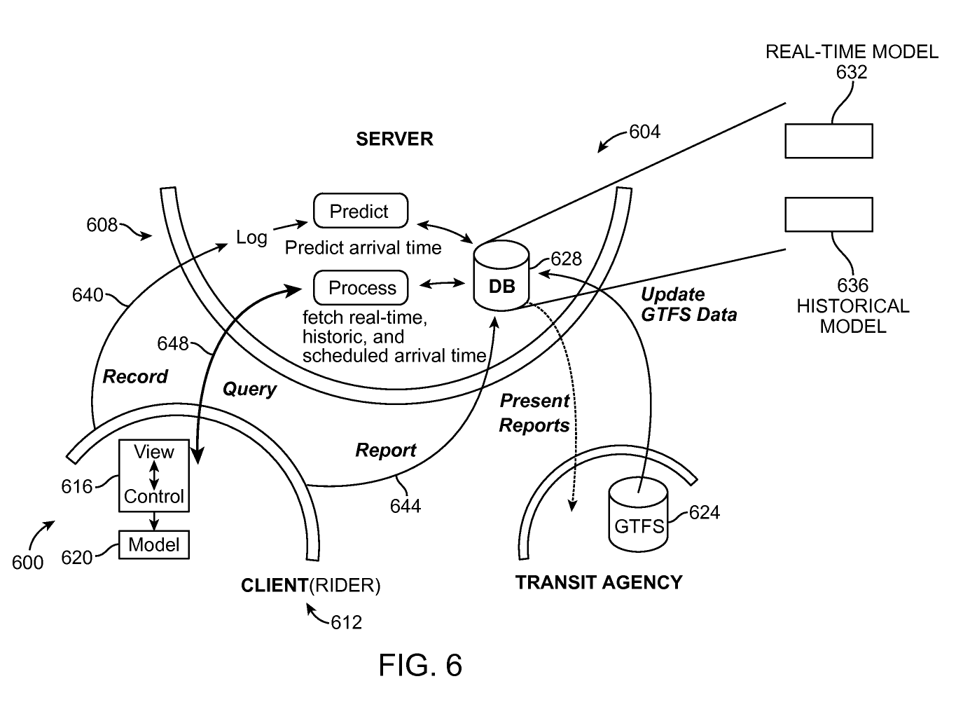

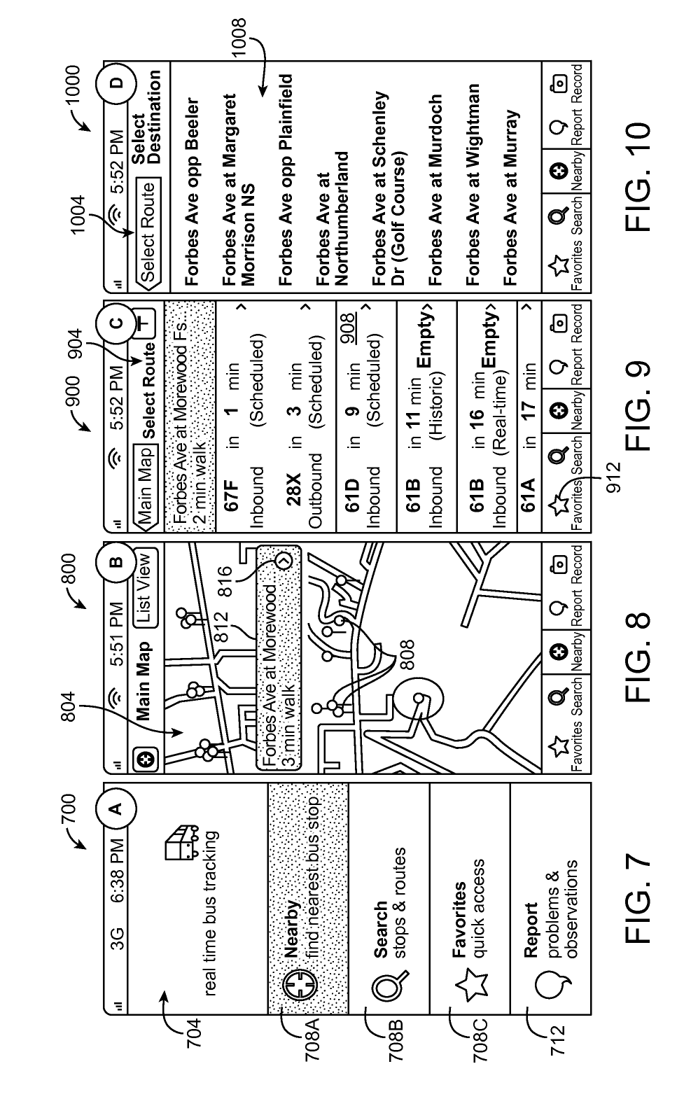

FIGS. 7 through 14 show screenshots of various GUI screens 700, 800, 900, 1000, 1100, 1200, 1300, 1400, respectively, generated by clients 612 (FIG. 6). Turning now to FIG. 7, screenshot 700 shows a main menu screen 704, from which users can access information on bus arrival times in three ways: nearby, search, and favorites, which can be selected using corresponding respective soft buttons 708A, 708B, 708C. Selecting “Nearby” button 708A transitions the GUI to a main map screen 804 shown in screenshot 800 of FIG. 8. In this embodiment, main map screen 804 offers a view similar to the current version of GOOGLE™ maps. Nearby stops appear as pins 808. Selecting any of pins 808 brings up a map annotation, such as annotation 812, with the name of the stop and the time of the next bus. Each annotation includes a button (button 816 on annotation 812) for navigating to a select route screen 904, which is shown in screenshot 900 of FIG. 9.

Selecting button 816 (FIG. 8) on an annotation transitions to select route screen 904 (FIG. 9), which displays a list 908 of upcoming buses for the selected stop. Select route screen 904 displays real-time arrival information for a bus when there is at least one commuter on that bus who is sharing locating data via a client 612 (FIG. 6). When that data is not available, select route screen 904 shows historic arrival information, assuming the system has previous trace data for this bus at this time. When neither real-time nor historic arrival information are available, the interface shows the scheduled arrival time obtained from GTFS database 624 (FIG. 6). In designing select route screen 904, it was chosen to combine real-time, historic, and schedule information as a way of addressing the bootstrapping challenge of getting crowd-sourced information into system 600. It was also chosen to not show the difference between the real-time and the scheduled arrival times, the intention being to help commuters know when the bus is coming, and not to shame the transit service by revealing that their bus may be earlier or later than scheduled.

In this example, real-time and historical data include bus fullness information, something currently not available as an estimate in the schedule provided by the transit service. Fieldwork with commuters revealed their unhappiness when they would see a bus they wanted coming towards and then have it drive past them because it was too full to allow more people to board. It was assumed that knowing ahead of time that a bus was full might lessen the blow of watching it drive past without stopping. Additionally, it was thought that commuters could use this information during rush-hour to decide if they should wait a few minutes in order to ride a bus that is less crowded. Moreover, it was felt that fullness information would benefit commuters with walkers, wheelchairs, strollers, and large bags.

Selecting a star button 912 in the lower left corner of select route screen 904 adds this stop to a commuter's list of favorites. Additionally, selecting favorites button 708C from main menu screen 704 of FIG. 7 transitions client 612 (FIG. 6) directly to select route screen 904.

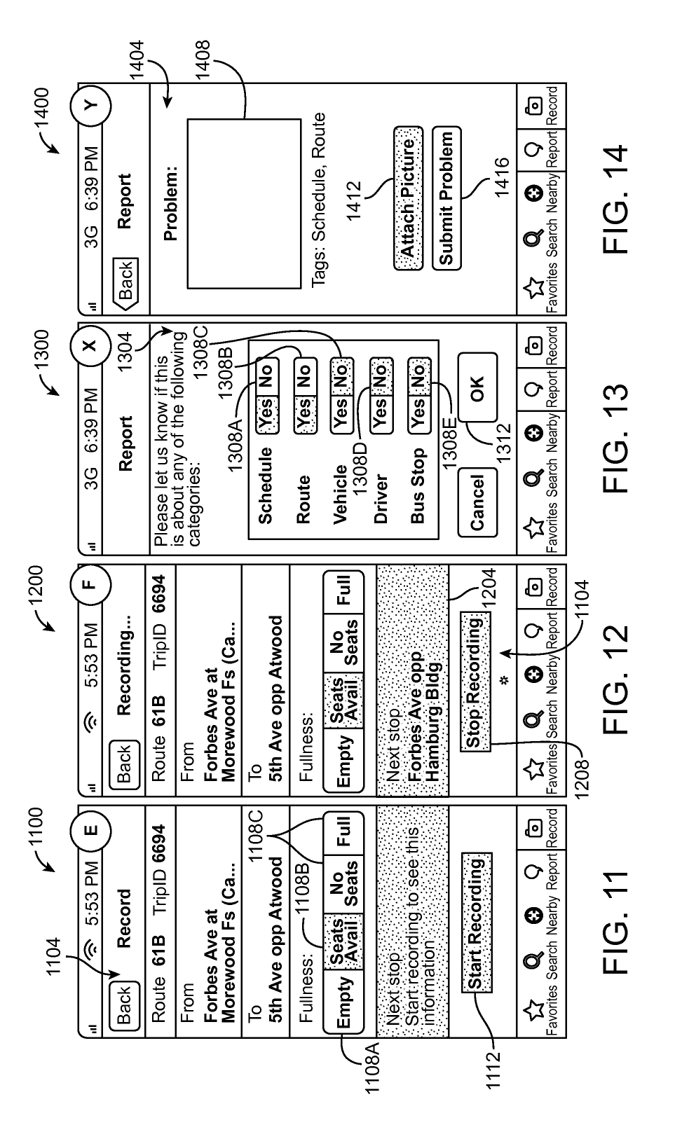

When commuters decide on the bus they wish to take, they select that bus from list 908 (FIG. 9) of arrival times, which transitions client 612 (FIG. 6) to a destination screen 1004 as shown in screenshot 1000 of FIG. 10. On destination screen 1004, commuters select from a list 1008 of upcoming stops. When commuters select a destination from list 1008, client 612 (FIG. 6) transitions to displaying a record screen 1104, as shown in screenshot 1100 of FIG. 11. Once a commuter boards the selected bus, they indicate fullness by selecting from among a plurality of soft buttons 1108A through 1108D, which here represent, respectively, that the bus is empty, seats are available, no seats are available, and the bus is full. After selecting one of fullness buttons 1108A through 1108D, the commuter selects a start recording button 1112 to provide the selected fullness rating to server 604 (FIG. 6) and initiate the providing of locating data (i.e., trace information) to the server. While tracing, client 612 (FIG. 6) displays next stop information in portion 1204 of record screen 1104, as illustrated in screenshot 1200 of FIG. 12. It is noted that client 612 will not display the next stop information unless and until the user selects start recording button 1112 on recording screen 1104 of FIG. 11. Rather, recording screen 1104 will display a message that conveys to the commuter that they need to start recording in order to see the next stop information, such as message 1116 in FIG. 11. It is believed that this setup will motivate commuters to record locating data report fullness information and thereby contribute to the quantity of crowd sourced information, which will enhance the accuracy and robustness of system 600 (FIG. 6). At the end of the trip, commuters press a stop recording button 1208 on recording screen 1104 as they exit, as illustrated in screenshot 1204 of FIG. 12.

In addition to buttons 708A to 708C for accessing stop information, main menu screen 704 of FIG. 7 also includes a report button 712 that allows commuters to report a condition on the bus other than fullness, such as, but not limited to availability of a bike rack, availability of space for wheeled mobility devices, mechanical issue with the bus (e.g., inadequate air conditioning), among others, or otherwise express positive or negative comments about their transit experience. In this embodiment, selecting report button 712 on main menu screen 704 causes client 612 (FIG. 6) to display a report type screen 1304, which is illustrated in screenshot 1300 of FIG. 13. It is also noted that a commuter can access report type screen 1304 from any of screens 804, 904, 1004, 1104, and 1204 using a report button 800.

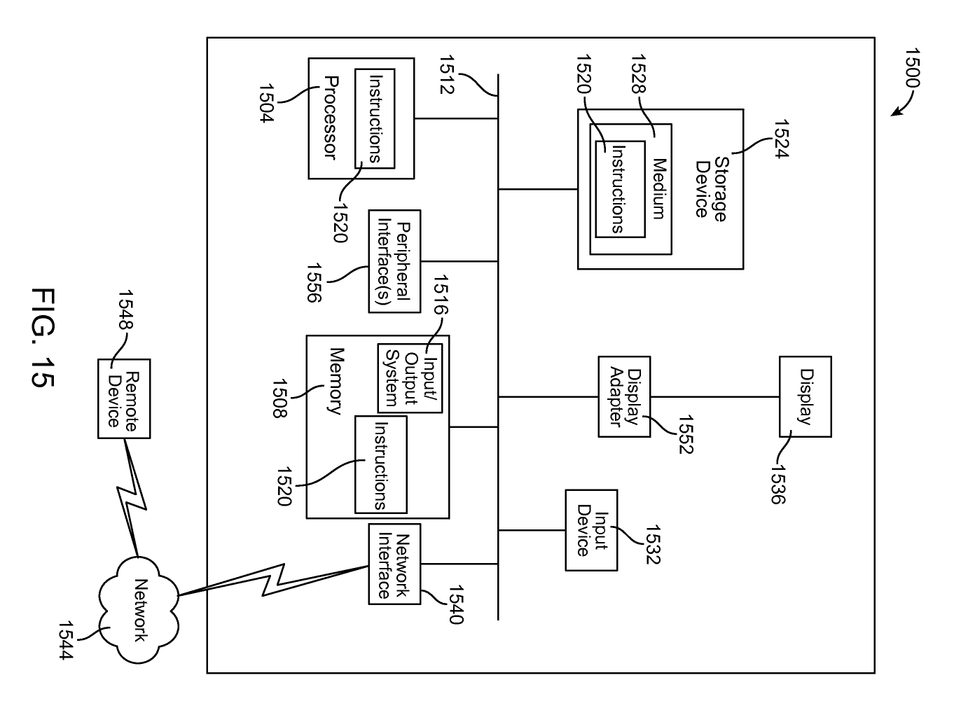

Report type screen 1304 of FIG. 13 allows the commuters to select the type of report(s) the commuters are making. In this example, report type screen includes five yes-no soft slide switches 1308A to 1308E for indicating whether the report contains, respectively, a report regarding schedule, route, vehicle, driver, and bus stop. Server 604 (FIG. 6) can then use this information in determining how to handled the report(s). By commuters selecting an okay button 1312 on report type screen 1304, client 612 (FIG. 6) navigates to a report submission screen 1404, illustrated in screenshot 1400 of FIG. 14. In this example, report submission screen 1404 provides a comment region 1408 that allows commuters to input a written description. Client 612 (FIG. 6) of this example also has the functionality of allowing commuters to attach a photograph of the condition. That functionality is accessed using an attach picture soft button 1412 on report submission screen 1404. When commuters are done entering a description and/or attaching a photograph, they submit the report to server 604 (FIG. 6) by selecting a submit problem button 1416 on report submission screen 1404.

### Exemplary Computer System

FIG. 15 shows a diagrammatic representation of one embodiment of a computer in the exemplary form of a computer system 1500 within which a set of instructions for causing implementing either of a shared-vehicle client application or shared-vehicle server application of the present disclosure, such as client applications 116(1)-(n) and 228 of FIGS. 1 and 2 and server applications 112 and 316 of FIGS. 1 and 3, respectively, to perform any one or more of the aspects and/or methodologies of the present disclosure. As an example, computer system 1500 can be used as mobile client devices 108(1)-(n) and 200 of FIGS. 1 and 2 and servers 104 and 300 of FIGS. 1 and 3, respectively. It is contemplated that multiple computing devices may be utilized to implement a specially configured set of instructions for causing the device to perform any one or more of the aspects and/or methodologies of the present disclosure. Computer system 1500 includes a processor 1504 and a memory 1508 that communicate with each other, and with other components, via a bus 1512. Bus 1512 may include any of several types of bus structures including, but not limited to, a memory bus, a memory controller, a peripheral bus, a local bus, and any combinations thereof, using any of a variety of bus architectures.

Memory 1508 may include various components (e.g., machine readable media) including, but not limited to, a random access memory component (e.g, a static RAM “SRAM”, a dynamic RAM “DRAM”, etc.), a read only component, and any combinations thereof. In one example, a basic input/output system 1516 (BIOS), including basic routines that help to transfer information between elements within computer system 1500, such as during start-up, may be stored in memory 1508. Memory 1508 may also include (e.g., stored on one or more machine-readable media) instructions (e.g., software) 1520 embodying any one or more of the aspects and/or methodologies of the present disclosure. In another example, memory 1508 may further include any number of program modules including, but not limited to, an operating system, one or more application programs, other program modules, program data, and any combinations thereof.

Computer system 1500 may also include a storage device 1524. Examples of a storage device (e.g., storage device 1524) include, but are not limited to, a hard disk drive for reading from and/or writing to a hard disk, a magnetic disk drive for reading from and/or writing to a removable magnetic disk, an optical disk drive for reading from and/or writing to an optical medium (e.g., a CD, a DVD, etc.), a solid-state memory device, and any combinations thereof. Storage device 1524 may be connected to bus 1512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1524 (or one or more components thereof) may be removably interfaced with computer system 1500 (e.g., via an external port connector (not shown)). Particularly, storage device 1524 and an associated machine-readable storage medium 1528 may provide nonvolatile and/or volatile storage of machine-readable instructions, data structures, program modules, and/or other data for computer system 1500. In one example, software 1520 may reside, completely or partially, within machine-readable storage medium 1528. In another example, software 1520 may reside, completely or partially, within processor 1504. It is noted that the term “machine-readable storage medium” does not include signals present on one or more carrier waves.

Computer system 1500 may also include an input device 1532. In one example, a user of computer system 1500 may enter commands and/or other information into computer system 1500 via input device 1532. Examples of an input device 1532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 1532 may be interfaced to bus 1512 via any of a variety of interfaces (not shown) including, but not limited to, a serial interface, a parallel interface, a game port, a USB interface, a FIREWIRE interface, a direct interface to bus 1512, and any combinations thereof. Input device 1532 may include a touch screen interface that may be a part of or separate from display 1536, discussed further below. Input device 1532 may be utilized as a user selection device for selecting one or more graphical representations in a graphical interface as described above.

A user may also input commands and/or other information to computer system 1500 via storage device 1524 (e.g., a removable disk drive, a flash drive, etc.) and/or network interface device 1540. A network interface device, such as network interface device 1540 may be utilized for connecting computer system 1500 to one or more of a variety of networks, such as network 1544, and one or more remote devices 1548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1544, may employ a wired and/or a wireless mode of communication. In general, any network topology may be used. Information (e.g., data, software 1520, etc.) may be communicated to and/or from computer system 1500 via network interface device 1540.

Computer system 1500 may further include a video display adapter 1552 for communicating a displayable image to a display device, such as display device 1536. Examples of a display device include, but are not limited to, a liquid crystal display (LCD), a cathode ray tube (CRT), a plasma display, a light emitting diode (LED) display, and any combinations thereof. Display adapter 1552 and display device 1536 may be utilized in combination with processor 1504 to provide a graphical representation of a utility resource, a location of a land parcel, and/or a location of an easement to a user. In addition to a display device, a computer system 1500 may include one or more other peripheral output devices including, but not limited to, an audio speaker, a printer, and any combinations thereof. Such peripheral output devices may be connected to bus 1512 via a peripheral interface 1556. Examples of a peripheral interface include, but are not limited to, a serial port, a USB connection, a FIREWIRE connection, a parallel connection, and any combinations thereof.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of providing information relating to a shared vehicle, comprising:
receiving first tracing information concerning the route of the shared vehicle from a first client device carried by a rider of the shared vehicle, wherein said receiving is a function of the rider initiating transmission of the first tracing information using a begin-transmission feature on the first client device;
digitally calculating an estimated arrival/departure time at a destination as a function of the first tracing information; and
providing the estimated arrival/departure time to a second client device viewable by a person interested in the arrival/departure time.

2. A method according to claim 1, further comprising receiving user-report information relating to the shared vehicle from the first client device, wherein said receiving is a function of the rider entering the user-report information into the first client device.

3. A method according to claim 2, wherein the shared vehicle is a multi-passenger vehicle and said receiving user-report information includes receiving information about the fullness of the multi-passenger vehicle.

4. A method according to claim 2, wherein said receiving user-report information includes receiving information about availability of a service provided aboard the shared vehicle.

5. A method according to claim 4, wherein said receiving user-report information includes receiving information about accommodations for wheeled mobility devices.

6. A method according to claim 1, wherein said digitally calculating the estimated arrival/departure time includes combining the first tracing information with historical trace data.

7. A method according to claim 1, wherein said digitally calculating the estimated arrival/departure time includes combining the first tracing information with second tracing information received contemporaneously with the first tracing information.

8. A method according to claim 1, further comprising ending said receiving the first tracing information in response to the rider stopping the transmission of the first tracing information using an end-transmission feature on the first client device.

9. A method according to claim 1, further comprising automatically determining that the rider is no longer aboard the shared vehicle.

10. A method according to claim 9, further comprising ending said receiving the first tracing information in response to determining that the rider is no longer aboard the shared vehicle.

11. A method according to claim 10, wherein said ending said receiving includes sending a transmission termination signal to the first client device.

12. A method according to claim 1, further comprising receiving from the second client device an indication that the person wants to rendezvous with the shared vehicle at the destination.

13. A method according to claim 12, further comprising transmitting a reminder to the second client device as a function of the estimated arrival/departure time.

14. A method according to claim 13, further comprising receiving location information about the location of the second client device, wherein said transmitting the reminder includes transmitting the reminder as a function of the location of the second client device.

15. A method according to claim 1, wherein said receiving first tracing information includes receiving sensor data from the first client device.

16. A method of collecting and receiving information relating to a shared vehicle, comprising:
displaying to a user on a client device an identifier of the shared vehicle;
receiving from the user via the client device a selection indicating the shared vehicle;
in response to said receiving the selection indicating the shared vehicle, causing the client device to transmit an indication of the selection to a remote shared vehicle information server;
displaying to the user on the client device a first control for initiating transmission of trace information generated by the client device;
receiving from the user via the client device a selection of the first control;
in response to said receiving the selection of the first control, transmitting the trace information to the remote shared vehicle information server;
displaying to the user on the client device an input mechanism that allows the user to input user-report information relating to the shared vehicle;
receiving from the user via the input mechanism the user-report information; and
transmitting the user-report information to the remote shared vehicle information server.

17. A method according to claim 16, further including displaying schedule information for the shared vehicle in conjunction with the identifier of the shared vehicle.

18. A method according to claim 16, wherein the shared vehicle operates on a route having designated stops and the method further includes displaying additional stop information only if the user has selected the first control.

19. A method according to claim 16, wherein said displaying the input mechanism includes displaying a fullness state input mechanism that allows the user to indicate fullness of the shared vehicle.

20. A method according to claim 19, wherein said displaying the fullness state input mechanism includes displaying a plurality of selectable controls corresponding to differing levels of fullness.

21. A method according to claim 16, wherein said displaying the input mechanism includes displaying a bicycle accommodations availability input mechanism that allows the user to indicate availability of bicycle accommodations on the shared vehicle.

22. A method according to claim 16, wherein said displaying the input mechanism includes displaying a wheeled mobility device accommodations availability input mechanism that allows the user to indicate availability of wheeled mobility device accommodations on the shared vehicle.

23. A method according to claim 16, further comprising displaying to the user via the client device a prompt that prompts the user to input the user-report information into the input mechanism.

24. A method according to claim 16, further comprising displaying to the user on the client device a second control for ending transmission of the trace.

25. A method according to claim 24, further comprising displaying to the user on the client device a prompt that prompts the user about ending transmission of the trace.

26. A method according to claim 16, further comprising providing to the user on the client device a rendezvous-setting interface that allows the user to schedule a rendezvous with the shared vehicle.

27. A method according to claim 26, further comprising providing to the user on the client device a rendezvous reminder that is a function of the location of the client device.

28. A method of providing information relating to a shared vehicle, comprising:
electronically receiving crowd-sourced trace data for a shared vehicle that runs on a schedule;
automatedly updating a schedule-based computer model for the shared vehicle as a function of the crowd-sourced trace data so as to create an updated model; and
electronically providing updated schedule information based on the updated model to a mobile client device carried by a user.

29. A method according to claim 28, wherein said electronically receiving crowd-sourced trace data includes electronically receiving crowd-source trace data in real time from a plurality mobile client devices carried by riders of the shared vehicles.

30. A method according to claim 28, wherein said electronically receiving crowd-sourced trace data includes electronically receiving instances of crowd-sourced trace data previously recorded on corresponding respective ones of a plurality of mobile client devices carried by riders of the shared vehicles.

31. A method according to claim 28, wherein said automatedly updating the schedule-based computer model includes automatedly determining a predicted arrival/departure time using the crowd-sourced trace data, and said electronically providing updated schedule information includes providing the predicted arrival/departure time to the mobile client device.

32. A method according to claim 28, further comprising electronically receiving crowd-sourced user-report information relating to the shared vehicle.

33. A method according to claim 32, further comprising electronically providing information to the mobile client device as a function of the crowd-sourced user-report information.

34. A method according to claim 32, further comprising electronically providing information to a customer service system as a function of the crowd-sourced user-report information.

35. A method according to claim 32, wherein said electronically receiving crowd-sourced user-report information includes receiving information concerning the condition of the shared vehicle.

36. A method according to claim 32, wherein said electronically receiving crowd-sourced user-report information includes receiving information about the experience of a rider of the shared vehicle.

37. A method according to claim 28, further comprising electronically receiving a rendezvous scheduling request made by a person.

38. A method according to claim 37, further comprising automatedly determining a rendezvous departure time.

39. A method according to claim 38, further comprising electronically providing the rendezvous departure time for viewing by the person.

40. A method according to claim 38, further comprising automatedly sending a rendezvous departure time reminder for perception by the person.

41. A machine-readable storage medium containing machine-executable instructions for performing a method of providing information relating to a shared vehicle, said machine-executable instructions comprising:
a first set of machine-executable instructions for receiving first tracing information concerning the route of the shared vehicle from a first client device carried by a rider of the shared vehicle, wherein said receiving is a function of the rider initiating transmission of the first tracing information using a begin-transmission feature on the first client device;
a second set of machine-executable instructions for digitally calculating an estimated arrival/departure time at a destination as a function of the first tracing information; and
a third set of machine-executable instructions for providing the estimated arrival/departure time to a second client device viewable by a person interested in the arrival/departure time.

42. A machine-readable storage medium according to claim 41, further comprising machine-executable instructions for receiving user-report information relating to the shared vehicle from the first client device, wherein the receiving is a function of the rider entering the user-report information into the first client device.

43. A machine-readable storage medium according to claim 42, wherein the shared vehicle is a multi-passenger vehicle and said machine-executable instructions for receiving user-report information includes machine-executable instructions for receiving information about the fullness of the multi-passenger vehicle.

44. A machine-readable storage medium according to claim 42, wherein said machine-executable instructions for receiving user-report information includes machine-executable instructions for receiving information about availability of a service provided aboard the shared vehicle.

45. A machine-readable storage medium according to claim 42, wherein said machine-executable instructions for receiving user-report information includes machine-executable instructions for receiving information about accommodations for wheeled mobility devices.

46. A machine-readable storage medium according to claim 41, wherein said second set of machine-executable instructions includes machine-executable instructions for combining the first tracing information with historical trace data.

47. A machine-readable storage medium according to claim 41, wherein said second set of machine-executable instructions includes machine-executable instructions for combining the first tracing information with second tracing information received contemporaneously with the first tracing information.

48. A machine-readable storage medium according to claim 41, further comprising machine-executable instructions for ending said receiving the first tracing information in response to the rider stopping the transmission of the first tracing information using an end-transmission feature on the first client device.

49. A machine-readable storage medium according to claim 41, further comprising machine-executable instructions for automatically determining that the rider is no longer aboard the shared vehicle.

50. A machine-readable storage medium according to claim 49, further comprising machine-executable instructions for ending said receiving the first tracing information in response to determining that the rider is no longer aboard the shared vehicle.

51. A machine-readable storage medium according to claim 50, wherein said machine-executable instructions for ending said receiving includes machine-executable instructions for sending a transmission termination signal to the first client device.

52. A machine-readable storage medium according to claim 41, further comprising machine-executable instructions for receiving from the second client device an indication that the person wants to rendezvous with the shared vehicle at the destination.

53. A machine-readable storage medium according to claim 52, further comprising machine-executable instructions for transmitting a reminder to the second client device as a function of the estimated arrival/departure time.

54. A machine-readable storage medium according to claim 53, further machine-executable instructions for comprising receiving location information about the location of the second client device, wherein said machine-executable instructions for transmitting the reminder includes transmitting the reminder as a function of the location of the second client device.

55. A machine-readable storage medium according to claim 41, wherein said machine-executable instructions for receiving first tracing information includes receiving sensor data from the first client device.

56. A machine-readable storage medium method of collecting and receiving information relating to a shared vehicle, comprising:
a first set of machine-executable instructions for displaying to a user on a client device an identifier of the shared vehicle;
a second set of machine-executable instructions for receiving from the user via the client device a selection indicating the shared vehicle;
a third set of machine-executable instructions for causing the client device to transmit an indication of the selection to a remote shared vehicle information server in response to said receiving the selection indicating the shared vehicle;
a fourth set of machine-executable instructions for displaying to the user on the client device a first control for initiating transmission of trace information generated by the client device;
a fifth set of machine-executable instructions for receiving from the user via the client device a selection of the first control;
a sixth set of machine-executable instructions for transmitting the trace information to the remote shared vehicle information server in response to the receiving the selection of the first control;
a seventh set of machine-executable instructions for displaying to the user on the client device an input mechanism that allows the user to input user-report information relating to the shared vehicle;
an eighth set of machine-executable instructions for receiving from the user via the input mechanism the user-report information; and
a ninth set of machine-executable instructions for transmitting the user-report information to the remote shared vehicle information server.

57. A machine-readable storage medium according to claim 56, further including machine-executable instructions for displaying schedule information for the shared vehicle in conjunction with the identifier of the shared vehicle.

58. A machine-readable storage medium according to claim 56, wherein the shared vehicle operates on a route having designated stops and said machine-executable instructions further include machine-executable instructions for displaying additional stop information only if the user has selected the first control.

59. A machine-readable storage medium according to claim 56, wherein said seventh set of machine-executable instructions includes machine-executable instructions for displaying a fullness state input mechanism that allows the user to indicate fullness of the shared vehicle.

60. A machine-readable storage medium according to claim 59, wherein said machine-executable instructions for displaying the fullness state input mechanism includes machine-executable instructions for displaying a plurality of selectable controls corresponding to differing levels of fullness.

61. A machine-readable storage medium according to claim 56, wherein said seventh set of machine-executable instructions includes machine-executable instructions for displaying a bicycle accommodations availability input mechanism that allows the user to indicate availability of bicycle accommodations on the shared vehicle.

62. A machine-readable storage medium according to claim 56, wherein said seventh set of machine-executable instructions includes machine-executable instructions for displaying a wheeled mobility device accommodations availability input mechanism that allows the user to indicate availability of wheeled mobility device accommodations on the shared vehicle.

63. A machine-readable storage medium according to claim 56, further comprising machine-executable instructions for displaying to the user via the client device a prompt that prompts the user to input the user-report information into the input mechanism.

64. A machine-readable storage medium according to claim 56, further comprising machine-executable instructions for displaying to the user on the client device a second control for ending transmission of the trace.

65. A machine-readable storage medium according to claim 64, further comprising machine-executable instructions for displaying to the user on the client device a prompt that prompts the user about ending transmission of the trace.

66. A machine-readable storage medium according to claim 56, further comprising machine-executable instructions for providing to the user on the client device a rendezvous-setting interface that allows the user to schedule a rendezvous with the shared vehicle.

67. A machine-readable storage medium according to claim 66, further comprising machine-executable instructions for providing to the user on the client device a rendezvous reminder that is a function of the location of the client device.

68. A machine-readable storage medium of providing information relating to a shared vehicle, comprising:
a first set of machine-executable instructions for receiving crowd-sourced trace data for a shared vehicle that runs on a schedule;
a second set of machine-executable instructions for updating a schedule-based computer model for the shared vehicle as a function of the crowd-sourced trace data so as to create an updated model; and
a third set of machine-executable instructions for providing updated schedule information based on the updated model to a mobile client device carried by a user.

69. A machine-readable storage medium according to claim 68, wherein said first set of machine-executable instructions includes machine-executable instructions for receiving crowd-source trace data in real time from a plurality mobile client devices carried by riders of the shared vehicles.

70. A machine-readable storage medium according to claim 68, wherein said first set of machine-executable instructions includes machine-executable instructions for receiving instances of crowd-sourced trace data previously recorded on corresponding respective ones of a plurality of mobile client devices carried by riders of the shared vehicles.

71. A machine-readable storage medium according to claim 68, wherein said second set of machine-executable instructions includes machine-executable instructions for determining a predicted arrival/departure time using the crowd-sourced trace data, and said third set of machine-executable instructions includes machine-executable instructions for providing the predicted arrival/departure time to the mobile client device.

72. A machine-readable storage medium according to claim 68, further comprising machine-executable instructions for receiving crowd-sourced user-report information relating to the shared vehicle.

73. A machine-readable storage medium according to claim 72, further comprising machine-executable instructions for providing information to the mobile client device as a function of the crowd-sourced user-report information.

74. A machine-readable storage medium according to claim 72, further comprising machine-executable instructions for providing information to a customer service system as a function of the crowd-sourced user-report information.

75. A machine-readable storage medium according to claim 72, wherein said machine-executable instructions for electronically receiving crowd-sourced user-report information includes machine-executable instructions for receiving information concerning the condition of the shared vehicle.

76. A machine-readable storage medium according to claim 72, wherein said machine-executable instructions for receiving crowd-sourced user-report information includes machine-executable instructions for receiving information about the experience of a rider of the shared vehicle.

77. A machine-readable storage medium according to claim 68, further comprising machine-executable instructions for receiving a rendezvous scheduling request made by a person.

78. A machine-readable storage medium according to claim 77, further comprising machine-executable instructions for determining a rendezvous departure time.

79. A machine-readable storage medium according to claim 78, further comprising machine-executable instructions for providing the rendezvous departure time for viewing by the person.

80. A machine-readable storage medium according to claim 78, further comprising machine-executable instructions for sending a rendezvous departure time reminder for perception by the person.
